(19) United States
(12) Patent Application Publication
(10) Pub. No.: US 2015/0185988 A1
(43) Pub. Date: Jul. 2, 2015

(54) METHOD, APPARATUS AND RECORDING MEDIUM FOR GUIDING TEXT EDITING POSITION

(71) Applicant: Samsung Electronics Co., Ltd., Gyeonggi-do (KR)

(72) Inventors: Soe-Youn Yim, Seoul (KR); Seung-Wook Nam, Gyeonggi-do (KR)

(21) Appl. No.: 14/587,363

(22) Filed: Dec. 31, 2014

(30) Foreign Application Priority Data
Dec. 31, 2013 (KR) 10-2013-0168349

(51) Int. Cl. G06F 3/0483; G10L 15/26; G06F 3/0488

(52) U.S. Cl. CPC G06F 3/0483; G06F 3/0488; G10L 15/26

(57) ABSTRACT

A method for guiding a text editing position is provided, which includes when generation of a touch event at a position in a text editing window is detected, determining a type of the touch event; and performing a predetermined function with respect to a word including letters located at the detected touch event-generated position according to the determined type of the touch event.

### PRIORITY

This application claims priority under 35 U.S.C. §119(a) to Korean Patent Application Serial No. 10-2013-0168349, which was filed in the Korean Intellectual Property Office on Dec. 31, 2013, the entire content of which is incorporated herein by reference.

### BACKGROUND

1. Field of the Invention

The present invention generally relates to a method, an apparatus, and a recording medium for guiding a text editing position according to a touch input in a touch screen.

2. Description of the Related Art

Recently, electronic devices such as smart phones, tablet PCs, and the like adopt a function that provides so called “Talkback” environment for providing a voice feedback for visually-impaired persons. Electronic devices configured with a Talkback environment read text in a touch screen by using technologies of exploring by a touch and Text to Speech (TTS). For example, when a user touches text in an input window with a finger and moves the finger, the electronic device outputs the text at the position of the finger through a voice to allow the user to recognize the text.

The visually-impaired persons using electronic devices with a configuration of the Talkback environment have a difficulty to find a text editing position when they intend to edit text such as an input or deletion of text.

Referring to FIGS. 1A to 1D, in the conventional electronic devices configured with the Talkback environment, the operation of selecting a text editing position for editing text in a text editing window 10, that is, for an input or deletion of text, is performed as follows. First, as shown in FIG. 1A, when a tap 11, that is, a type of touch as described below, is input in a text editing window 10, the electronic device generates a focus at the position of the input of the tap 11, and outputs information stating that it is a text editing window 10 and all the letters in the text editing window 10 through a voice. Next, as shown in FIG. 1B, a double tap 12, that is, another type of touch as described below, is input in the text editing window 10, the text editing window is converted to an editing mode. At this time, a cursor 14 is generated at the position of the input of the double tap 12 as shown in FIG. 1C, and a handler 15 indicating the position of the cursor 14 is displayed. In addition, when the double tap 12 and a hold-and-move 13, that is, another type of touch as described below, are input, the cursor 14 and the handler 15 are displaced to the position which the input of the hold-and-move 13 terminates as shown in FIG. 1D.

Here, the tap 11 refers to a gesture by which a user shortly and lightly taps on a touch screen once with one finger, and the double tap 12 denotes a gesture by which a user shortly and lightly taps on a touch screen twice with one finger. In addition, the hold-and-move 13 refers to a gesture by which a user puts his finger on a touch screen and moves the finger in a predetermined direction by a distance while maintaining the touch of the screen by the finger.

In the operation in FIGS. 1A to 1D, a user inputs the tap 11 to select a window including text to be edited, and then inputs the double tap 12 to display the cursor 14 and the handler 15 at the position of the input of the double tap 12. Therefore, a user needs to move the cursor 14 or the handler 15 to each letter one by one and recognize the context by listening to a voice in order to find a desired text editing position. The visually-impaired persons who are the majority of users for the Talkback have difficulty to exactly touch and move the cursor 14 or the handler 15, and to recognize the context by the Talkback reading the letters one by one due to a limitation resulting from a feature of the Talkback that reads the letter behind the cursor 14. That is, it is not easy for a user to find a certain position of text where the user intends to edit.

### SUMMARY

The present invention has been made to address at least the above-mentioned problems and/or disadvantages and to provide at least the advantages described below. Accordingly, an aspect of the present invention provides a method, and an apparatus and a recording medium for guiding a text editing position to identify words by a word-spacing of text and output a selected word through a voice according to generated touch events. That is, an electronic device of the present invention provides a voice output by a word as if the visually-impaired persons read Braille books to thereby allow a user to recognize the context intuitively.

Another aspect of the present invention provides a method, an apparatus and a recording medium for guiding a text editing position to display a cursor after a word selected by a generated touch event, and to output the last letter of the word through a voice. Accordingly, a user can intuitively recognize the position of a cursor, and the present invention provides quick access to the position where a user intends to edit so that the visually-impaired persons can easily read and edit a long sentence.

In accordance with an aspect of the present invention, a method for guiding a text editing position is provided, which includes when generation of a touch event at a position in a text editing window is detected, determining a type of the touch event; and performing a predetermined function with respect to a word including letters at the detected touch event-generated position according to the determined type of the touch event.

In accordance with another aspect of the present invention, an apparatus for guiding a text editing position is provided, which includes a touch screen; and a controller that, when generation of a touch event at a position in a text editing window is detected, determines a type of the touch event, and performs a predetermined function with respect to a word including letters at the detected touch event-generated position according to the determined type of the touch event.

In accordance with another aspect of the present invention, a recording medium for guiding a text editing position that records a program to perform is provided, which includes when generation of a touch event at a position in a text editing window is detected, determining a type of the touch event; and performing a predetermined function with respect to a word including letters at the detected touch event-generated position according to the determined type of the touch event.

### BRIEF DESCRIPTION OF THE DRAWINGS

The above and other aspects, features, and advantages of the present invention will be more apparent from the following detailed description, taken in conjunction with the accompanying drawings, in which:

FIGS. 1 A to 1D illustrate an operation of guiding a text editing position according to the prior art;

FIG. 2 is a block diagram of an electronic device for guiding a text editing position according to an embodiment of the present invention;

FIG. 3 is a flowchart illustrating the operation of guiding a text editing position according to an embodiment of the present invention;

FIGS. 4A to 4D illustrate an example of the operation of guiding a text editing position according to an embodiment of the present invention;

FIGS. 5A to 5C are flowcharts illustrating the operation of guiding a text editing position according to another embodiment of the present invention; and

FIGS. 6A to 6C, 7A to 7C, and 8A to 8B illustrate an example of the operation of guiding a text editing position according to another embodiment of the present invention.

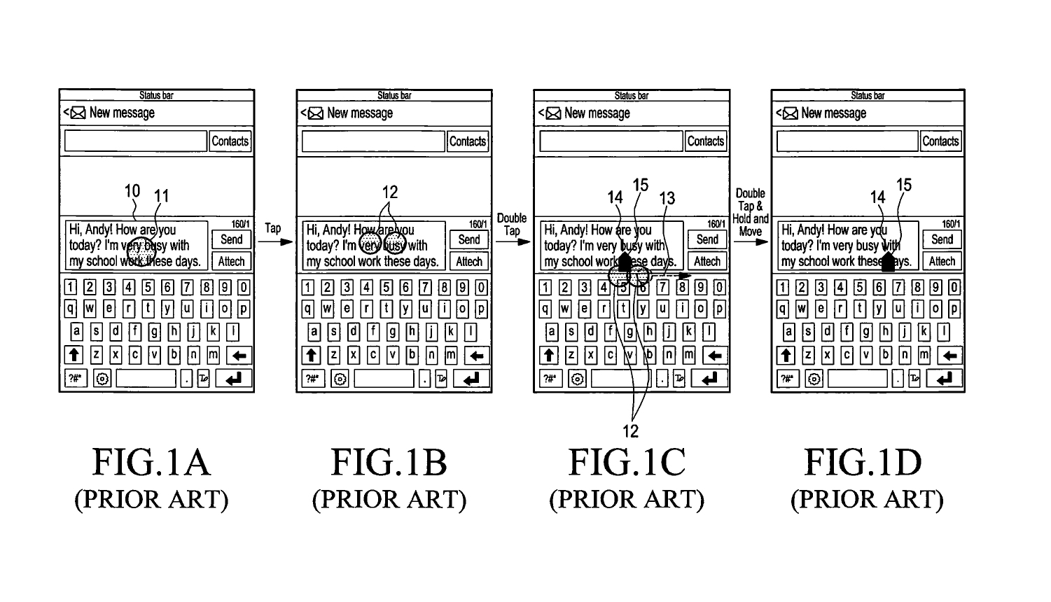

### DETAILED DESCRIPTION OF EMBODIMENTS OF THE PRESENT INVENTION

Hereinafter, embodiments of the present invention will be described in detail with reference to the accompanying drawings. Although specific text editing windows, handlers, taps, double tap, and the like are disclosed in the following description, these are provided to help overall understanding of the present invention, and it is obvious to those skilled in the art that these specific elements may be transformed or modified within the scope of the present invention.

A method, an apparatus and a recording medium for guiding a text editing position allows visually-impaired persons, who are the majority of users for electronic devices configured with a Talkback environment, to recognize text by a word through a finger touch when they read or edit the text of long sentences, which is similar to the way in which normal persons read text word by word. More specifically, electronic devices provide a voice output by a word as if the visually-impaired persons read Braille books to thereby allow a user to recognize the context intuitively. In addition, the present invention allows a user of electronic devices to intuitively recognize the position of a cursor, and provides quick access to the position where a user intends to edit so that visually-impaired persons can easily read and edit a long sentence.

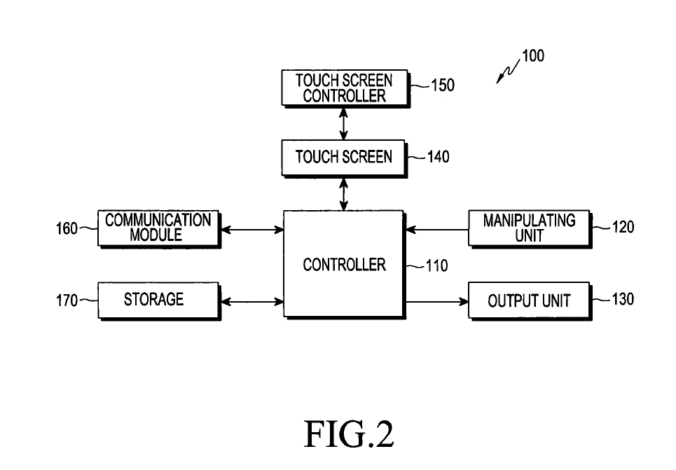

FIG. 2 is a block diagram of an electronic device for guiding a text editing position according to an embodiment of the present invention. Referring to FIG. 2, an electronic device 100 includes a manipulating unit 120, an output unit 130, a touch screen 140, a touch screen controller 150, a communication module 160, a memory 170, and a controller 110.

The manipulating unit 120 receives an input of a user's manipulation, and includes at least one of buttons and a keypad.

The buttons are provided on the front, side or rear surfaces of the electronic device 100, and may be at least one of a power/pause button and a menu button.

The keypad receives a key input from a user for controlling the electronic device 100. The keypad includes a physical keypad provided in the electronic device 100, or a virtual keypad displayed in the touch screen 140. The physical keypad provided in the electronic device 100 may be omitted according to the performance or the structure of the electronic device 100.

The output unit 130 includes a speaker, and further includes a vibrating motor.

The speaker outputs a sound corresponding to a function performed by the electronic device 100 under the control of the controller 110. One or a plurality of speakers are provided at a proper position(s) of the electronic device 100.

The vibrating motor converts an electric signal to a mechanical vibration according to the control of the controller 110. For example, when the electronic device 100 staying in a vibration mode receives a voice call from other electronic devices, the vibrating motor will operate. In addition, one or a plurality of vibrating motors may be provided in a housing of the electronic device 100. The vibrating motor operates in response to a user's touch gesture on the touch screen 140 and a continuous movement of a touch on the touch screen 140.

The touch screen 140 receives an input of a user's manipulation, and display execution images of application programs, an operation state, and a menu state. That is, the touch screen 140 provides a user with user interfaces corresponding to various services (e.g., a phone call, data transmission, broadcasts, photographing) The touch screen 140 transmits analog signals corresponding to at least one touch that is input by a user interface to the touch screen controller 150. The touch screen 140 receives at least one touch input through a hand touch or a touchable input means such as electronic pens (e.g., stylus pens, hereinafter referred to as an electronic pen). Also, the touch screen 140 receives a continuous input of the at least one touch. The touch screen 140 transmits analog signals corresponding to a continuous movement of a touch input to the touch screen controller 150.

In addition, the touch screen 140 may be implemented by, for example, a resistive type, a capacitive type, an ElectroMagnetic Resonance (EMR) type, an infrared type, or an acoustic wave type.

Further, touches of the present invention are not limited to direct touches such as hand touches or electronic pens with the touch screen 140, and may further include non-touching gestures. An interval that the touch screen 140 can detect may be changed depending on the performance and the structure of the electronic device 100. Particularly, in order to separately recognize a touch event by a hand touch or an electronic pen and a non-touching input event (e.g., a hovering), the touch screen 140 is configured to output different recognition values (e.g., a current value) according to the touch event and the hovering event, respectively. Preferably, the touch screen 140 outputs different recognition values (e.g., a current value) according to a distance between the place where the hovering event is generated and the touch screen 140.

Meanwhile, the touch controller 150 converts analog signals received from the touch screen 140 to digital signals (e.g., X and Y-coordinates) to be thereby transmitted to the controller 110. The controller 110 controls the touch screen 140 using the digital signals received from the touch screen controller 150. For example, the controller 110 allows icons displayed in the touch screen 140 to be selected or performs icons in response to the touch event or the hovering event. Further, the touch screen controller 150 may be included in the controller 110.

In addition, the touch screen controller 150 identifies a distance between a place where the hovering event is generated and the touch screen 140 by recognizing a value (e.g., a current value) output through the touch screen 140, and converts the identified distance value to a digital signal (e.g., a Z-coordinate) to be thereby provided to the controller 110.

Further, the touch screen 140 includes at least two touch screen panels that can recognize a hand touch and an electronic pen touch or proximity thereof, respectively, in order to receive inputs of a hand touch and an electronic pen simultaneously. The at least two touch screen panels provide different values to the touch screen controller 150, respectively, and the touch screen controller 150 separately recognizes the input values from the at least two touch screen panels to thereby determine whether the input from the touch screen results from a hand touch or an electronic pen.

The communication module 160 includes a mobile communication module, a wireless Local Area Network (LAN) module, and a local area communication module.

The mobile communication module allows the electronic device 100 to connect with external electronic devices through mobile communication using at least one or a plurality of antennae according to the control of the controller 110. The mobile communication module transmits/receives wireless signals for voice calls, video calls, text messages using Short Message Service (SMS) or multimedia messages using Multimedia Messaging Service (MMS) to/from mobile phones, smart phones, tablet PCs or other devices which have telephone numbers to be entered to the electronic device 100.

The wireless LAN module is connected with the Internet in the area where wireless access points (APs) are installed according to the control of the controller 110. The wireless LAN module supports the wireless LAN standard (IEEE 802.11x) of Institute of Electrical and Electronics Engineers (IEEE). The local area communication module may be Bluetooth, and perform nearby wireless communication between electronic devices according to the control of the controller 110.

The communication module 160 of the electronic device 100 includes at least one of the mobile communication module, the wireless LAN module, and the local area communication module depending on the performance thereof. For example, the communication module 160 includes a combination of the mobile communication module, the wireless LAN module, and the local area communication module depending on the performance thereof.

The memory 170 stores signals or data input/output to correspond to operations of the manipulating unit 120, the output unit 130, the touch screen 140, the touch screen controller 150, and the communication module 160 according to the control of the controller 110. The memory 170 stores control programs and applications for controlling the electronic device 100 or the controller 110.

Hereinafter, the term “memory” is interpreted to include the memory 170, a Read-Only Memory (ROM) and a Random-Access Memory (RAM) in the controller 110, and memory cards (e.g., Secure Digital (SD) cards, and memory sticks) installed in the electronic device 100. The memory 170 may include non-volatile memories, volatile memories, Hard Disk Drives (HDDs), or Solid State Drives (SSDs).

The controller 110 includes a Central Processing Unit (CPU), a ROM that stores control programs for controlling the electronic device 100, and a RAM that memorizes signals or data input from the outside of the electronic device 100 or that is used as a memory area for operations performed in the electronic device 100. The CPU may include a single core, dual cores, triple cores, or quad cores. The CPU, the ROM and the RAM may be connected with each other through an internal bus.

The controller 110 controls the manipulating unit 120, the output unit 130, the touch screen 140, the touch screen controller 150, the communication module 160, and the memory 170.

In addition, according to an embodiment of the present invention, when the generation of a touch event is detected in a predetermined text editing window displayed in the touch screen 140, the controller 110 identifies a word including letters at the detected touch event-generated position, and if the detected touch event is the first touch event, the controller 110 controls a speaker to output the identified word through a voice, or if the detected touch event is the second touch event, the controller 110 controls a cursor to be displayed at a predetermined position of the identified word. The operation of guiding a text editing position according to an embodiment of the present invention will be described in detail below.

Prior to describing the operation of embodiments of the present invention, the term “word” is explained as follows. A word is each element constituting a sentence, and it corresponds to word spacing. For example, in Korean, a “word” is made up of a single word or a combination of a single word and a postposition. Also, in English, a single word constitutes a “word”.

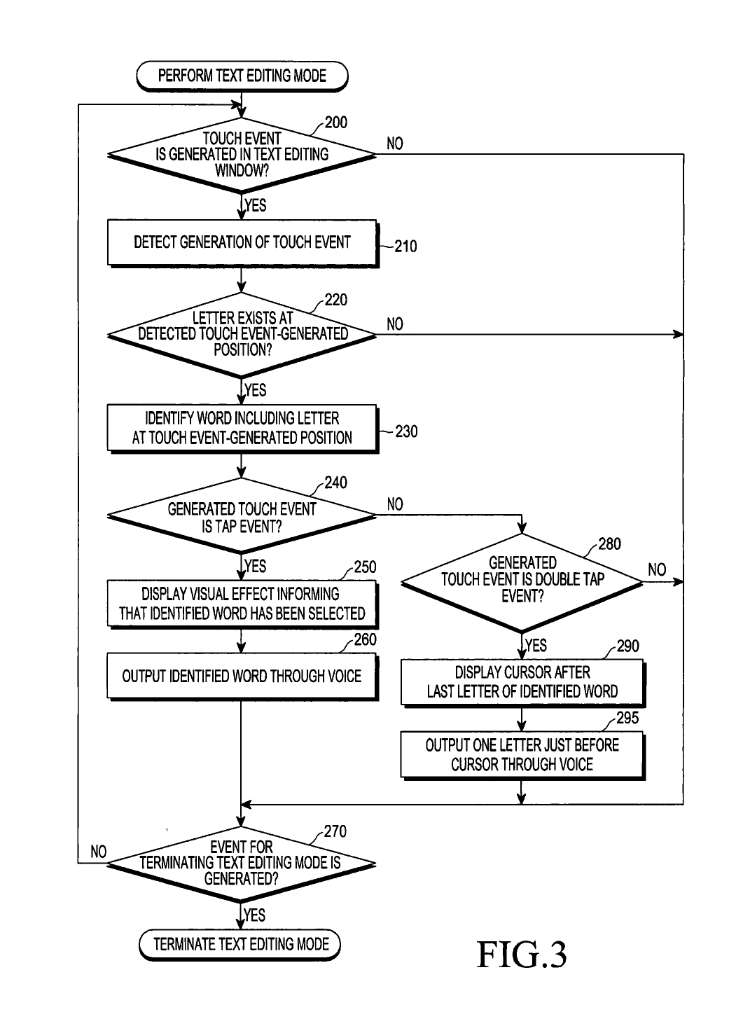

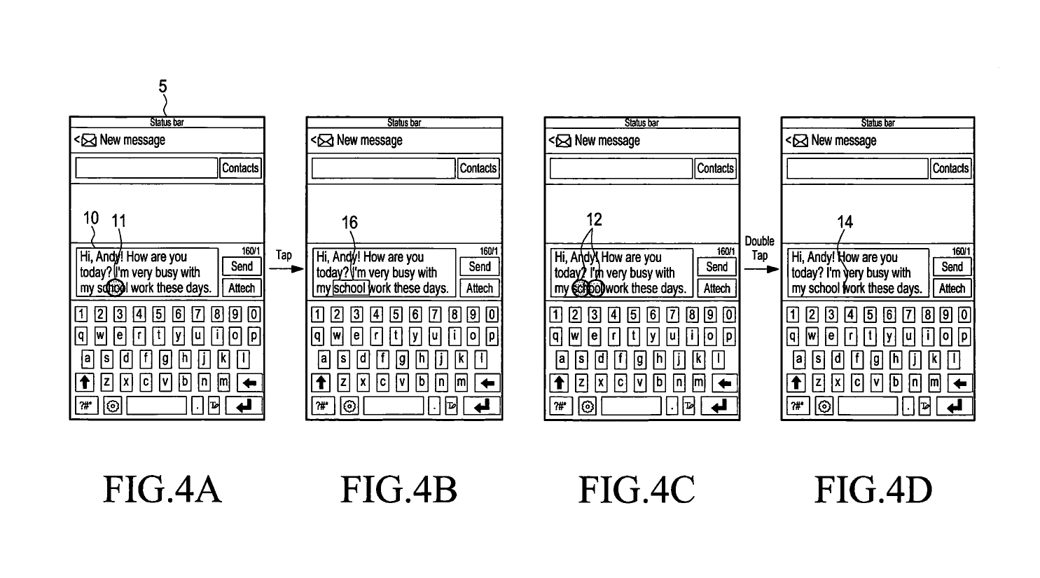

FIG. 3 is a flowchart illustrating the operation of guiding a text editing position according to an embodiment of the present invention, and FIGS. 4A to 4D illustrate an example of the operation of guiding a text editing position according to an embodiment of the present invention.

Referring to FIG. 3, upon performing a text editing mode, in step 200, it is determined whether a touch event is generated in a text editing window according to a user's touch input. At this time, the text editing mode is performed by a user's manipulation such as a voice input, a touch input, the pressing of buttons, or the like. When the text editing mode is performed, a predetermined text editing window for inputting and deleting letters is displayed in the screen. If it is determined that a touch event is generated in the text editing window in step 200, the sequence proceeds to step 210, and otherwise, if it is determined that a touch event is not generated in the text editing window in step 200, the sequence proceeds to step 270.

In step 210, the generation of a touch event in the text editing window is detected.

In step 220, it is determined whether letters exist at the generated position of the detected touch event. If it is determined that letters exist at the detected touch event-generated position in step 220, the sequence proceeds to step 230, and otherwise, if it is determined that letters do not exist at the detected touch event-generated position, the sequence proceeds to step 270.

In step 230, a word including the letters at the detected touch event-generated position is identified. In step 240, it is determined whether the generated touch event is a tap event. Here, the tap event denotes an event generated by a gesture of shortly and lightly tapping on a touch screen once with one finger among various touch events. If it is determined that the generated touch event is a tap event in step 240, the sequence proceeds to step 250, and otherwise, if it is determined that the generated touch event is not a tap event in step 240, the sequence proceeds to step 280.

In step 250, a predetermined visual effect, which informs that the word identified in step 230 has been selected, is displayed.

In step 260, the word identified in step 230 is output through a voice.

In step 270, it is determined whether an event for terminating the text editing mode is generated. The event for terminating the text editing mode is performed by predetermined instructions for terminating the text editing mode according to a user's manipulation such as voice instructions, touch inputs, the pressing of buttons, or the like. If it is determined that an event for terminating the text editing mode is generated in step 270, the text editing mode is terminated, and otherwise, if it is determined that an event for terminating the text editing mode is not generated, the sequence returns to step 200.

In step 280, it is determined whether the generated touch event is a double tap event. Here, the double tap event refers to an event generated by a gesture of shortly and lightly tapping on a touch screen twice with one finger among various touch events. If it is determined that the generated touch event is a double tap event in step 280, the sequence proceeds to step 290, and otherwise if it is determined that the generated touch event is not a double tap event in step 280, the sequence proceeds to step 270.

In step 290, a cursor is displayed after the last letter of the word identified in step 230. In step 295, one letter just before the cursor is output through a voice, and then the above-mentioned step 270 follows step 295.

According to the operation of the text editing mode in FIG. 3, referring to FIG. 4A, when a user inputs a tap 11 at the position where a certain letter exists in a text editing window 10 of a screen 5, the electronic device identifies a word including the letter at the position of the tap input to thereby display a predetermined visual effect 16 on the corresponding word as shown in FIG. 4B and outputs the corresponding word through a voice. In addition, when a user inputs a double tap 12 at the position where a certain letter exists in the text editing window 10 as shown in FIG. 4C, the electronic device identifies a word including the letter at the position of the double tap input to thereby display a cursor 14 behind the last letter of the corresponding word as shown in FIG. 4D and outputs one letter just in front of the cursor through a voice.

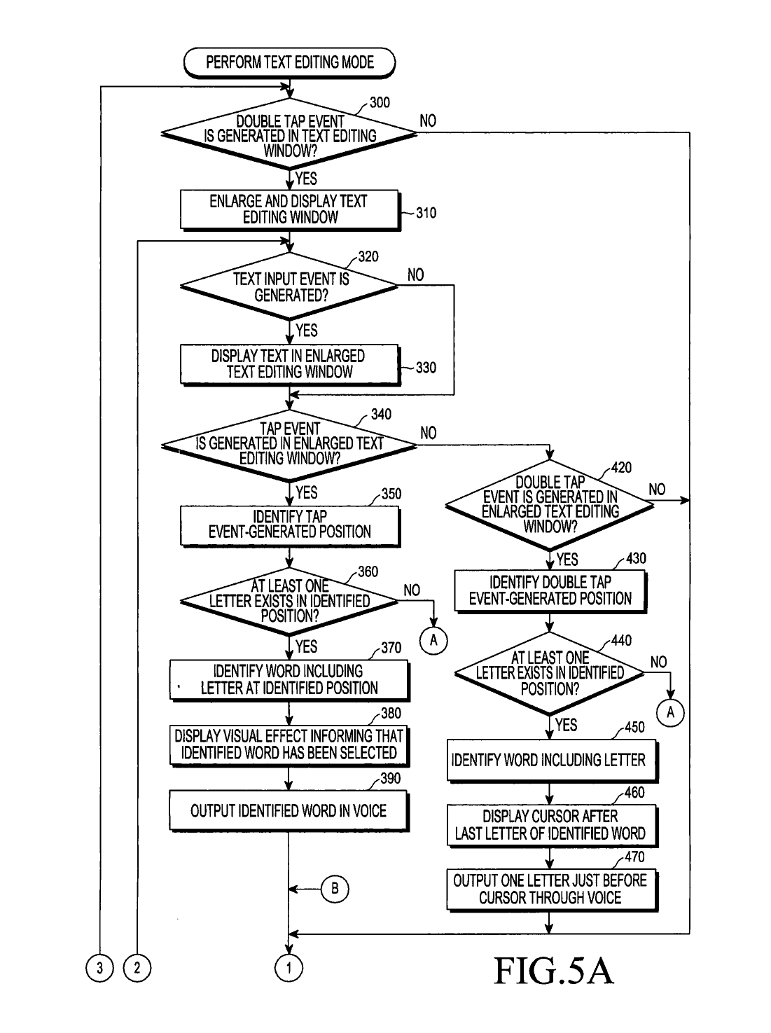

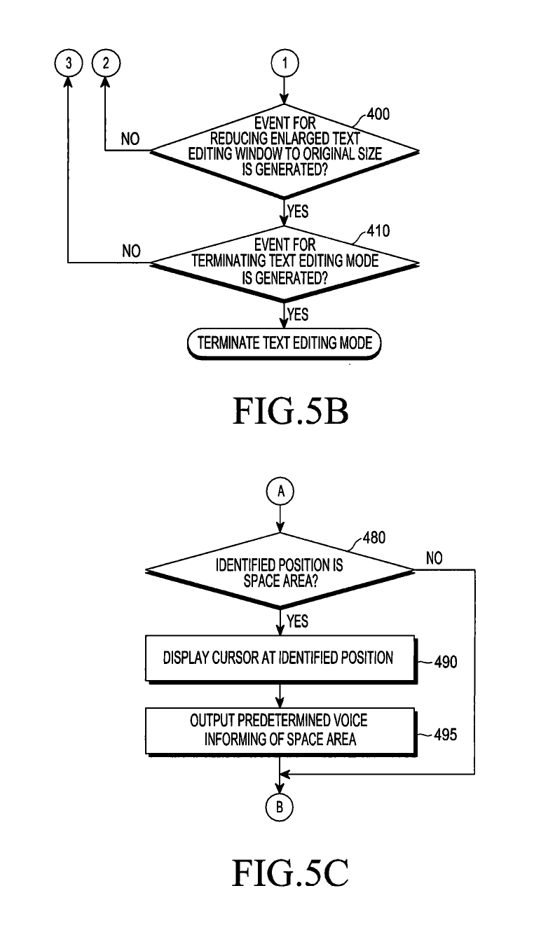

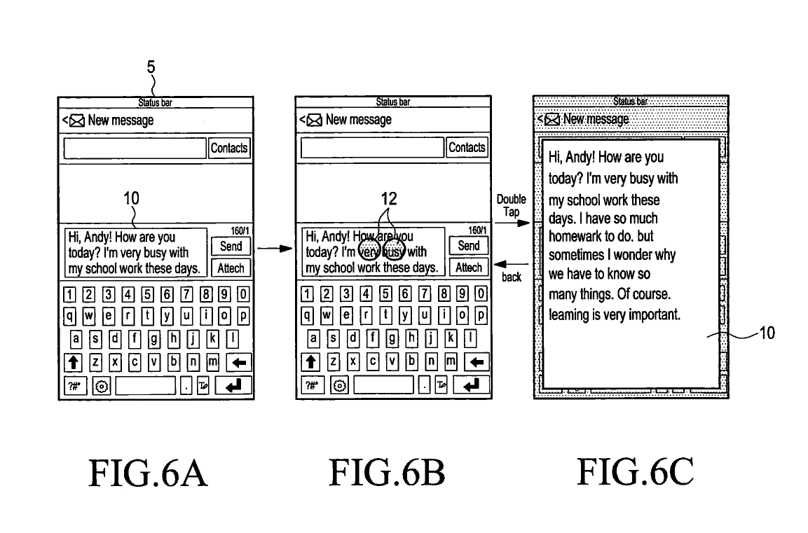

FIGS. 5A to 5C are flowcharts illustrating the operation of guiding a text editing position according to another embodiment of the present invention, and FIGS. 6A to 6C, 7A to 7C, and 8A to 8B illustrate the operation of guiding a text editing position according to another embodiment of the present invention.

Referring to FIGS. 5A to 5C, upon performing a text editing mode, in step 300, it is determined whether a double tap event is generated in a text editing window. If it is determined that a double tap event is generated in the text editing window in step 300, the sequence proceeds to step 310, and otherwise, if it is determined that a double tap event is not generated in the text editing window in step 300, the sequence proceeds to step 400.

In step 310, the text editing window is enlarged to a predetermined size to be thereby displayed. At this time, if pre-input text exists in the text editing window, the text may be enlarged at the same enlargement ratio as the text editing window, too.

In step 320, it is determined whether a text input event is generated in the text editing window. Here, the text input may be conducted by various user's manipulations such as voice inputs, touch inputs, or the like. If it is determined 20 that a text input event is generated in step 320, the sequence proceeds to step 330, and otherwise, if it is determined that a text input event is not generated in step 320, the sequence proceeds to step 340.

In step 330, text is displayed in the enlarged text editing window according to the generated text input event.

In step 340, it is determined whether a tap event is generated in the enlarged text editing window. If it is determined that a tap event is generated in the enlarged text editing window in step 340, the sequence proceeds to step 350, and otherwise, if it is determined that a tap event is not generated in the enlarged text editing window in step 340, the sequence proceeds to step 420.

In step 350, the position where the tap event is generated is identified.

In step 360, it is determined whether at least one letter exists at the identified tap event-generated position. If it is determined that at least one letter exists at the identified tap event-generated position in step 360, the sequence proceeds to step 370, and otherwise, if it is determined that at least one letter does not exist at the identified tap event-generated position in step 360, the sequence proceeds to step 480.

In step 370, a word including the letters at the detected tap event-generated position is identified. In step 380, a predetermined visual effect, which informs that the identified word has been selected, is displayed.

In step 390, the identified word is output through a voice.

In step 400, it is determined whether an event for reducing the enlarged text editing window to the original size is generated. Here, the event for reducing the enlarged text editing window to the original size is performed by predetermined instructions for reducing the text editing mode according to various user's manipulations such as voice instructions, touch inputs, the pressing of buttons, or the like. If it is determined that an event for reducing the enlarged text editing window to the original size is generated in step 400, the sequence proceeds to step 410, and otherwise, if it is determined that an event for reducing the enlarged text editing window to the original size is not generated in step 400, the sequence returns to step 320.

In step 410, it is determined whether an event for terminating the text editing mode is generated. If it is determined that an event for terminating the text editing mode is generated in step 410, the text editing mode is terminated, and otherwise, if it is determined that an event for terminating the text editing mode is not generated in step 410, the sequence returns to step 300.

In step 420, it is determined whether a double tap event is generated in the enlarged text editing window. If it is determined that a double tap event is generated in the enlarged text editing window in step 420, the sequence proceeds to step 430, and otherwise, if it is determined that a double tap event is not generated in the enlarged text editing window in step 420, the sequence proceeds to step 400.

In step 430, the position where the double tap event is generated is identified.

In step 440, it is determined whether at least one letter exists at the identified double tap event-generated position. If it is determined that at least one letter exists at the identified double tap event-generated position in step 440, the sequence proceeds to step 450, and otherwise, if it is determined that at least one letter does not exist at the identified double tap event-generated position in step 440, the sequence proceeds to step 480.

In step 450, a word including the letters at the identified double tap event-generated position is identified.

In step 460, a cursor is displayed after the last letter of the identified word.

In step 470, one letter just before the cursor is output through a voice, and then the above-mentioned step 400 follows step 470.

In step 480, it is determined whether the identified tap event-generated position or the identified double tap event-generated position is a space area. If it is determined that the identified tap event-generated position or the identified double tap event-generated position is a space area, the sequence proceeds to step 490, and otherwise, if it is determined that the identified tap event-generated position or the identified double tap event-generated position is not a space area, the sequence proceeds to step 400.

In step 490, a cursor is displayed at the identified tap event-generated position or the identified double tap event-generated position. In step 495 after step 490, a predetermined voice informing of a space area is output. Then, the above-mentioned step 400 follows step 495.

In the operation of enlarging the text editing window to be displayed in FIGS. 5A to 5C, when the generation of the double tap event is detected in the text editing window, the electronic device checks the size of the text editing window, and if the size of the text editing window does not correspond to a predetermined enlarged size, the text editing window is enlarged to be thereby displayed. At this time, the predetermined enlarged size is configured upon the manufacturing of the electronic device or by a user's setup.

In addition, according to the operations of FIGS. 5A to 5C, the operation of enlarging the text editing window to be displayed by the double tap event (hereinafter referred to as a first operation), and the operations of, when a letter exists at the double tap event-generated position, identifying a word including the corresponding letter, then displaying a cursor after the last letter of the identified word, and outputting one letter just before the cursor through a voice (hereinafter referred to as a second operation) are configured to be performed. Each operation according to the generation of the double tap event may be predetermined depending on the size of the text editing window. More specifically, if the size of the text editing window does not correspond to a predetermined enlarged size, it may be predetermined to perform the first operation upon the detection of the double tap event generation. Also, if the size of the text editing window corresponds to a predetermined enlarged size, it may be predetermined to perform the second operation upon the detection of the double tap event generation.

According to the operation of the text editing mode in FIGS. 5A to 5C, referring to FIG. 6A, in a text editing window 10 displayed in a screen 5, when a user inputs a double tap 12 at a certain position in the text editing window 10 as shown in FIG. 6B, the electronic device enlarges the text editing window 10 to be thereby displayed as shown in FIG. 6C.

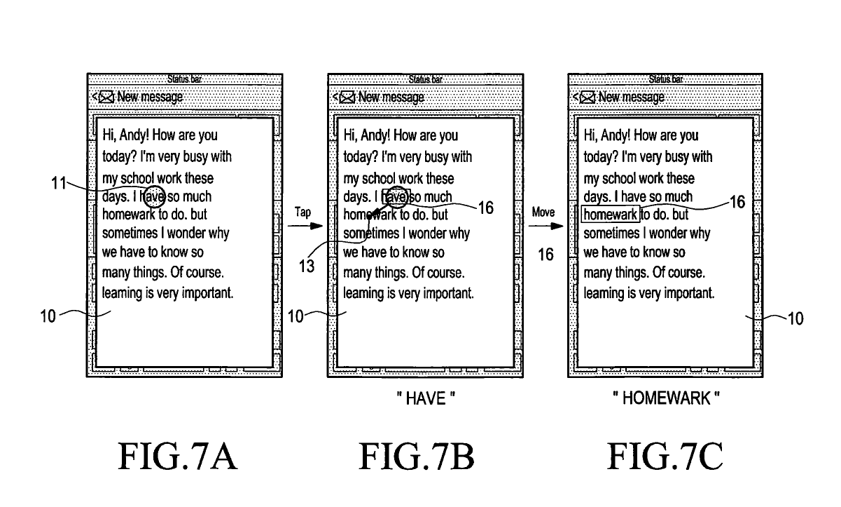

In addition, referring to FIG. 7A, when a user inputs a tap 11 at the position of a certain letter in the text editing window 10, the electronic device identifies a word including the letter at the position of the tap input to thereby display a predetermined visual effect 16 on the corresponding word as shown in FIG. 7B and outputs the corresponding word through a voice. That is, the tap 11 is input at the position of any letter of “have”, the visual effect 16 informing that “have” has been selected is displayed at the position where “have” exists and “have” is output through a voice.

Furthermore, although not described in the operations of FIGS. 5A to 5C, when a user inputs a hold-and-move 13 in a certain direction as shown in FIG. 7B, the electronic device identifies a word including the letter at the initial touch input position by a finger on the screen, and displays a visual effect 16 at the touch input position of the finger on the screen as shown in FIG. 7B. Then, as the touch moves to a new word, the electronic device identifies the new word and moves the visual effect 16 to the new word to be thereby displayed. The hold-and-move 13 is one of the touches, and refers to a gesture by which a user touches a screen with a finger and moves the finger while maintaining the touch of the screen in a predetermined direction by a distance. In addition, upon the display of the visual effect 16, the word displayed with the visual effect is simultaneously output through a voice. That is, when a user inputs a touch by a finger on some letters of “have”, then moves the finger toward “homework” with the finger touching the screen, and takes the finger off the position of “homework”, a visual effect 16 is initially displayed on “have” and then is moved to “homework” to be displayed thereon according to the hold-and-move operation. Further, upon the display of the visual effect 16, the corresponding word is simultaneously output through a voice.

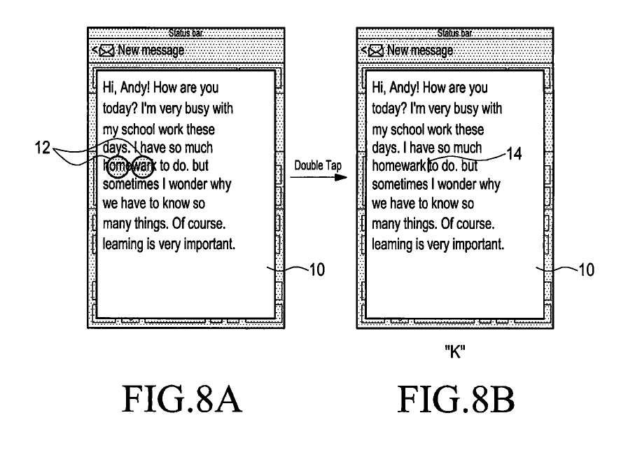

In addition, referring to FIG. 8A, when a user inputs a double tap 12 at the position where at least one letter of a word exists, the electronic device identifies a word including the letter at the position of the double tap input to thereby display a cursor after the last letter of the word as shown in FIG. 8B. At this time, one letter just before the cursor is output through a voice. That is, in order to edit “homework”, if a user inputs a double tap 12 at the position of any letter of “homework” as shown in FIG. 8A, the electronic device displays a cursor just after “homework” and outputs “K” through a voice as shown in FIG. 8B.

The operation of guiding a text editing position according to an embodiment of the present invention may be performed as described above. Meanwhile, although specific embodiments are described in the description of the invention, various examples, modifications and alterations can be made in addition to the above embodiments. Some or overall operations described in the present specification may be simultaneously and concurrently performed, or some of the operations may be omitted. Alternatively, other operations may be added.

For example, in the above embodiments, when events of a tap, a double tap and a hold-and-move are generated, a predetermined operation is performed according to each event. However, the touch event corresponding to a specific operation may be changed according to the configuration in manufacturing the electronic device or a user's setup. In addition, although the above embodiments provide a tap, a double tap, and a hold-and-move as touch events, various touch events may be applied according to the configuration in manufacturing the electronic device or a user's setup.

Further, although, when a touch event is generated, the operation of displaying and the operation of outputting a voice corresponding to the touch event are sequentially performed, the operation of displaying and the operation of outputting a voice corresponding to the touch event may be simultaneously performed. Alternatively, only one of the operation of displaying and the operation of outputting a voice corresponding to the touch event may be performed.

In addition, although a cursor is displayed after the last letter of a word in the present embodiments, the cursor may be displayed at any position, for example, before the first letter of a word, according to the configuration in manufacturing the electronic device or a user's setup.

Further, the text editing mode may be various modes such as a text message editing mode, a memo input mode, or the like.

It will be appreciated that embodiments of the present invention may be implemented in a form of hardware, software, a combination of hardware and software. Regardless of being erasable or re-recordable, such an optional software may be stored in a non-volatile storage device such as a ROM, a memory such as an RAM, a memory chip, a memory device, or an integrated circuit, or a storage medium such as a Compact Disc (CD), a Digital Video Disc (DVD), a magnetic disc, or a magnetic tape that is optically or electromagnetically recordable and readable by a machine, for example, a computer. It can be seen that a memory which may be included in the mobile terminal corresponds to an example of the storage medium suitable for storing a program or programs including instructions by which the embodiments of the present invention are realized. Accordingly, the present invention includes a program that includes a code for implementing an apparatus or a method defined in any claim in the present specification and a machine-readable storage medium that stores such a program. Further, the program may be electronically transferred by any communication signal through a wired or wireless connection, and the present invention appropriately includes equivalents of the program. While the present invention has been particularly shown and described with reference to certain embodiments thereof, various changes in form and detail may be made therein without departing from the spirit and scope of the present invention as defined by the following claims. Accordingly, the scope of the present invention will be defined by the appended claims and equivalents thereto.

What is claimed is:

1. A method for guiding a text editing position, the method comprising:
when generation of a touch event at a position in a text editing window is detected, determining a type of the touch event; and
performing a predetermined function with respect to a word including letters at the detected touch event-generated position according to the determined type of the touch event.

2. The method of claim 1, wherein performing the predetermined function with respect to the word including the letters at the detected touch event-generated position comprises, if the determined type of the touch event is a first touch event, outputting the word through a voice.

3. The method of claim 2, further comprising, if the determined type of the touch event is the first touch event, displaying a predetermined visual effect on the word.

4. The method of claim 3, further comprising, after the generation of the touch event is detected in a part of an area where the visual effect is displayed, when a movement event of the touch event in one direction is detected, and if there is a word other than the word at a touch movement event-generated position, moving the predetermined visual effect to the other word to be thereby displayed.

5. The method of claim 2, wherein the first touch event is a tap event that is generated by an input of a gesture of shortly and lightly tapping on a touch screen once with one finger.

6. The method of claim 1, wherein performing the predetermined function with respect to the word including the letters at the detected touch event-generated position comprises, if the determined type of the touch event is a second touch event, displaying a cursor at a predetermined position of the word.

7. The method of claim 6, further comprising, if the determined type of the touch event is the second touch event, outputting one letter included in the word through a voice according to the displayed position of the cursor.

8. The method of claim 6, wherein the second touch event is a double tap event that is generated by an input of a gesture of shortly and lightly tapping on a touch screen twice with one finger.

9. The method of claim 6, wherein the predetermined position of the word is a position after a last letter of the word.

10. The method of claim 9, further comprising, if the determined type of the touch event is the second touch event, outputting the last letter of the word through a voice.

11. The method of claim 1, wherein performing the predetermined function with respect to the word including the letters at the detected touch event-generated position comprises, if the determined type of the touch event is a third touch event, checking a size of the text editing widow, and if the size of the text editing window does not correspond to a predetermined enlarged size, enlarging the size of the text editing window to be thereby displayed.

12. The method of claim 11, further comprising, if the size of the text editing window corresponds to the predetermined enlarged size, displaying a cursor at a predetermined position of the word.

13. An apparatus for guiding a text editing position, the apparatus comprising:
a touch screen; and
a controller configured to, when generation of a touch event at a position in a text editing window is detected, determine a type of the touch event, and perform a predetermined function with respect to a word including letters at the detected touch event-generated position according to the determined type of the touch event.

14. The apparatus of claim 13, further comprising a speaker, wherein, if the determined type of the touch event is a first touch event, the controller is further configured to output the word through a voice through the speaker.

15. The apparatus of claim 13, wherein, if the determined type of touch event is a first touch event, the controller is further configured to display a predetermined visual effect on the word.

16. The apparatus of claim 15, wherein, after the generation of the touch event is detected in a part of an area where the visual effect is displayed, when a movement event of the touch event in one direction is detected, and if there is a word other than the word at a touch movement event-generated position, the controller is further configured to move the predetermined visual effect to the other word to be thereby displayed.

17. The apparatus of claim 14, wherein the first touch event is a tap event that is generated by an input of a gesture of shortly and lightly tapping on a touch screen once with one finger.

18. The apparatus of claim 13, wherein, if the determined type of the touch event is a second touch event, the controller is further configured to display a cursor at a predetermined position of the word.

19. The apparatus of claim 18, further comprising a speaker, wherein, if the determined type of the touch event is the second touch event, the controller is further configured to output one letter included in the word through a voice through the speaker according to the displayed position of the cursor.

20. The apparatus of claim 18, wherein the second touch event is a double tap event that is generated by an input of a gesture of shortly and lightly tapping on a touch screen twice with one finger.

21. The apparatus of claim 18, wherein the predetermined position of the word is a position after a last letter of the word.

22. The apparatus of claim 21, further comprising a speaker, and wherein, if the determined type of the touch event is the second touch event, the controller is further configured to output the last letter of the word through a voice.

23. The apparatus of claim 13, wherein, if the determined type of the touch event is a third touch event, the controller is further configured to check a size of the text editing widow, and if the size of the text editing window does not correspond to a predetermined enlarged size, enlarges the size of the text editing window to be thereby displayed.

24. The apparatus of claim 23, wherein, if the size of the text editing window corresponds to the predetermined enlarged size, displaying a cursor at the predetermined position of the word.

25. A recording medium for guiding a text editing position, the medium recording a program to perform:
when generation of a touch event at a position in a text editing window is detected, determining a type of the touch event; and
performing a predetermined function with respect to a word including letters at the detected touch event-generated position according to the determined type of the touch event.
